(19) United States
(12) Patent Application Publication
(10) Pub. No.: US 2016/0004676 A1
(43) Pub. Date: Jan. 7, 2016

(54) DISPLAYING WEB PAGES

(71) Applicant: International Business Machines Corporation, Armonk, NY (US)

(72) Inventors: Mayumi Goto, Kanagawa (JP); Yoshio Horiuchi, Kanagawa-ken (JP); Hirotaka Matsumoto, Kanagawa (JP)

(21) Appl. No.: 14/691,979

(22) Filed: Apr. 21, 2015

(30) Foreign Application Priority Data
Jul. 2, 2014 (JP) 2014-136926

(51) Int. Cl. G06F 17/22; G06F 17/30; H04L 29/08

(52) U.S. Cl. CPC G06F 17/2247; H04L 67/02; G06F 17/30887

(57) ABSTRACT

A data processing unit extracts identification information which identifies contents of displayed dynamic content from a Web page displayed on a display device and holds the identification information in a content information holding unit. A display control unit checks, in relation to dynamic content contained in a Web page to be newly displayed on the display device, whether or not identification information which identifies contents of the dynamic content at a specific time point is held, if the Web page is the same Web page as a currently displayed Web page or is a Web page displayed previously, and displays the dynamic content of the newly displayed Web page based on the identification information about the dynamic content contained in the newly displayed Web page if the identification information is held.

### CROSS-REFERENCE TO RELATED APPLICATION

This application is related to and claims the benefit of Japan Patent Application No. 2014-136926, filed Jul. 2, 2014, which application is incorporated by reference herein for all purposes.

### BACKGROUND

The present invention relates to displaying Web pages.

Some Web pages contain dynamic content as a component. The dynamic content is Web content generated dynamically by a Web server in response to, for example, a request from a client. The dynamic content may have its display contents changed each time a Web page containing the dynamic content is displayed by a Web browser. Its display contents may also be changed while a Web page is displayed in response to a request from a client, with the passage of time, or the like.

### SUMMARY

In some embodiments, the present invention is implemented as an apparatus for displaying Web pages on a display device, which includes: a dynamic content distinguishing unit adapted to distinguish whether or not a Web page displayed on the display device contains dynamic content; a content information extraction unit adapted to extract identification information which identifies contents of the displayed dynamic content from the Web page determined by the dynamic content distinguishing unit as containing dynamic content; a content information holding unit adapted to hold the identification information extracted by the content information extraction unit; and a display control unit adapted to control display of Web pages on the display device, and, if dynamic content is contained in a Web page to be newly displayed and the identification information about the dynamic content is held in the content information holding unit, display the dynamic content of the newly displayed Web page based on the identification information held in the content information holding unit.

In some embodiments, if there are a plurality of pieces of the identification information about the dynamic content contained in the newly displayed Web page, the display control unit accepts selection of contents of the dynamic content by a user, and displays the dynamic content based on the identification information about the selected contents of the dynamic content.

Further, in some embodiments, when a Web page displayed on the display device prior to a currently displayed Web page is to be redisplayed as the Web page to be newly displayed, the display control unit displays dynamic content contained in the Web page, based on the identification information held in the content information holding unit.

Also, in some embodiments, if a currently displayed Web page is to be reloaded and redisplayed as the Web page to be newly displayed, the display control unit displays dynamic content contained in the Web page, based on the identification information held in the content information holding unit.

Also, more specifically, in some embodiments, the content information extraction unit extracts the identification information about dynamic content when a Web page containing the dynamic content is displayed on the display device, when the dynamic content contained in the Web page displayed on the display device is updated, when displaying a Web page containing the dynamic content is finished, or at each predetermined time.

In some embodiments, the present invention is also implemented as a method for displaying Web pages on a display device, which includes the steps of: checking, in relation to dynamic content contained in a Web page to be newly displayed on the display device, whether or not identification information which identifies contents of the dynamic content at a specific time point is held, if the Web page is the same Web page as a currently displayed Web page or is a Web page displayed previously; and displaying the dynamic content of the newly displayed Web page based on the identification information about the dynamic content contained in the newly displayed Web page if the identification information is held. In some embodiments, the method further includes a step of extracting the identification information which identifies contents of the displayed dynamic content from the Web page displayed on the display device and holding the identification information.

Furthermore, in some embodiments the present invention is implemented as a program configured to implement functions of the apparatus described above by controlling a computer or as a program configured to cause a computer to perform processes corresponding to the steps described above. The program can be provided by being distributed on a magnetic disk, optical disk, semiconductor memory, or other recording medium or by being distributed via a network.

In some embodiments, the present invention is also implemented as another method. As part of the method, a uniform resource locator (URL) for a first Web page is obtained. By using the URL to retrieve the first Web page, a first version of the first Web page is provided. As provided, the first version of the first Web page includes visual static content and a first content version of a plurality of content versions of visual dynamic content. The visual static content is configured to remain the same each time the first Web page is displayed and the visual dynamic content is configured to change between the plurality of content versions each time the first Web page is displayed. A determination is made that there is visual dynamic content contained in the first Web page. In response to the determination identification information for the first content version of the visual dynamic content is extracted. After the extracting the identification information, a switch is made from providing the first version of the first webpage to providing a second webpage. Then, after this switching, the first version of the first Web page is reprovided by using the URL to retrieve the static content of the first Web page and by using the identification information to retrieve the first content version of the dynamic content.

In some embodiments, the present invention may make it easy to view a Web page containing desired contents of dynamic content displayed previously.

### BRIEF DESCRIPTION OF THE DRAWINGS

FIG. 1 is a diagram showing an example configuration of a Web page viewing system, in accordance with some embodiments of the present invention;

FIG. 2 is a diagram showing a functional configuration of a Web server, in accordance with some embodiments of the present invention;

FIG. 3 is a diagram showing a functional configuration of a client terminal, in accordance with some embodiments of the present invention;

FIG. 4 is a flowchart describing a dynamic-content extraction process performed by the client terminal, in accordance with some embodiments of the present invention;

FIGS. 5(a) and 5(b) are diagrams showing an example of an HTML file of a Web page likely to contain dynamic content, where FIG. 5(a) is a diagram showing source code of the HTML file and FIG. 5(b) is a diagram showing a display example of the Web page, in accordance with some embodiments of the present invention;

FIGS. 6(a) and 6(b) are diagrams showing another example of an HTML file of a Web page likely to contain dynamic content, where FIG. 6(a) is a diagram showing source code of the HTML file and FIG. 6(b) is a diagram showing a display example of the Web page, in accordance with some embodiments of the present invention;

FIGS. 7(a) and 7(b) are diagrams showing another example of an HTML file of a Web page likely to contain dynamic content, where FIG. 7(a) is a diagram showing source code of the HTML file and FIG. 7(b) is a diagram showing a display example of the Web page, in accordance with some embodiments of the present invention;

FIGS. 8(a) and 8(b) are diagrams showing special description examples in an HTML file of a Web page, where FIG. 8(a) is a diagram showing an example of passing a parameter to a URL and FIG. 8(b) is a diagram showing an example in which a URL contains a path generated dynamically, in accordance with some embodiments of the present invention;

FIG. 9 is a flowchart describing a Web page redisplay process based on history information, in accordance with some embodiments of the present invention;

FIG. 10 is a diagram showing an example of a selection screen, in accordance with some embodiments of the present invention;

FIG. 11 is a diagram showing an example configuration of a selection screen which switchably displays dynamic content on a Web page, in accordance with some embodiments of the present invention; and

FIG. 12 is a diagram showing a hardware configuration example suitable for constructing the client terminal, in accordance with some embodiments of the present invention.

### DETAILED DESCRIPTION

Embodiments of the present invention will be described in detail below with reference to the accompanying drawings.

After transition from a Web page containing dynamic content to another Web page, if one goes back to the Web page containing the dynamic content, the dynamic content may have changed from what it was before the transition to the other Web page. Consequently, it may not be possible to view the dynamic content as it was displayed before the transition to the other Web page.

Also, if contents of dynamic content change while a Web page is being displayed, it may be difficult to go back to the desired contents of the dynamic content existing before the change.

Some embodiments of the present invention may allow information about a Web page containing dynamic content to be saved together with contents of the dynamic content and thereby make it easier to view the Web page in a form containing desired contents of the dynamic content.

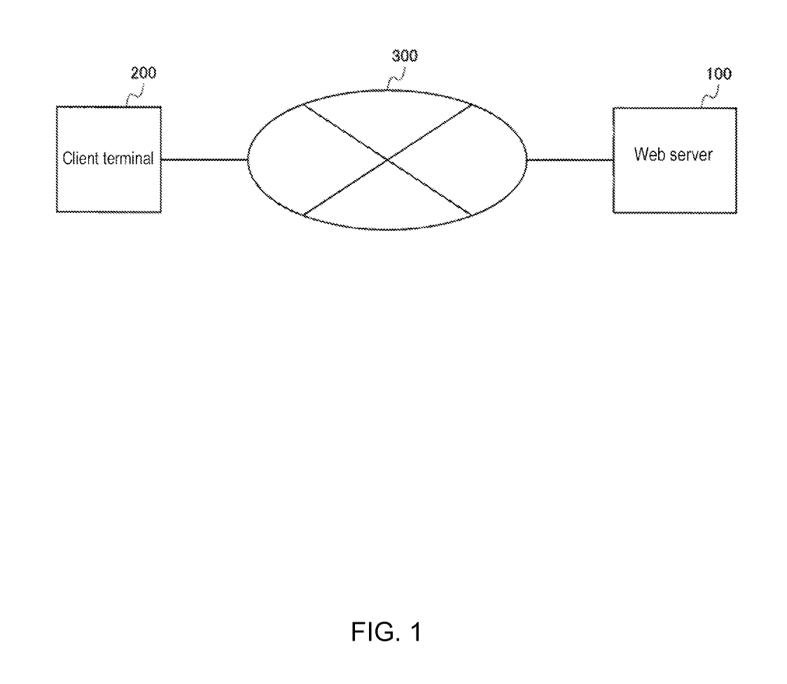

FIG. 1 is a diagram showing a configuration example of a Web page viewing system, in accordance with some embodiments of the present invention. The Web page viewing system shown in FIG. 1 includes a Web server 100 and a client terminal 200. As shown in FIG. 1, the Web server 100 and client terminal 200 are interconnected via a network 300 such as the Internet. Note that although one Web server 100 and one client terminal 200 are illustrated in FIG. 1, in some embodiments multiple Web servers 100 and multiple client terminals 200 may be interconnected, making up the system.

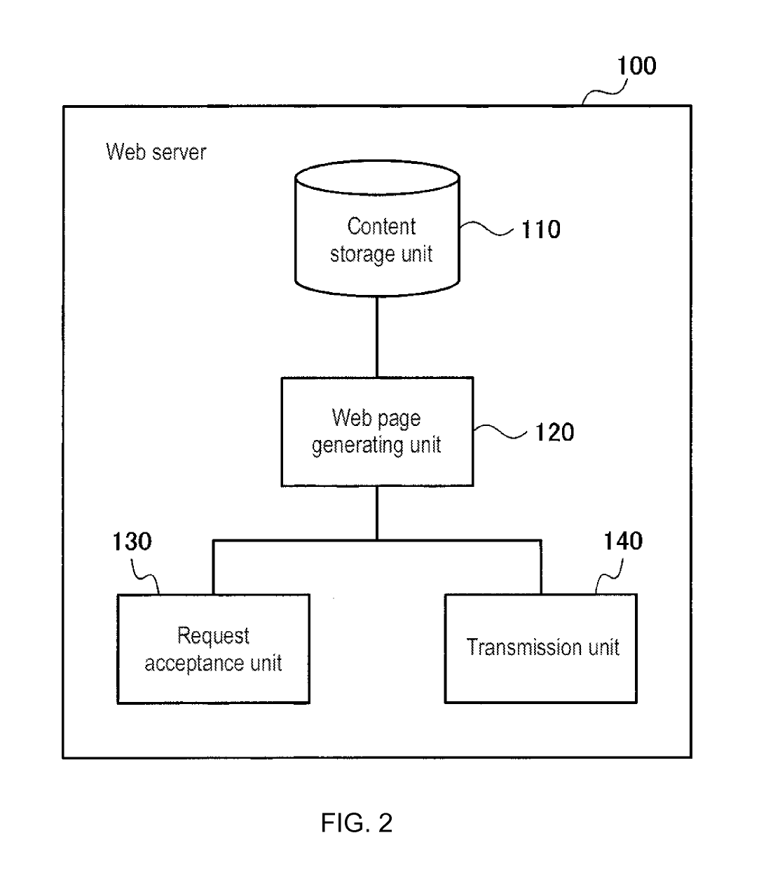

FIG. 2 is a diagram showing a functional configuration of the Web server 100, in accordance with some embodiments of the present invention. The Web server 100 according to some embodiments may be a typical Web server 100 which returns Web page data in response to a request from the client terminal 200. As shown in FIG. 2, the Web server 100 includes a content storage unit 110, a Web page generating unit 120, a request acceptance unit 130, and a transmission unit 140.

The content storage unit 110 may store an HTML file of a Web page, content such as images displayed on the Web page, programs for generating dynamic content (e.g., servlets and Java Server Pages), and the like. The HTML file stored in the content storage unit 110 may include static content prepared as a component of the Web page beforehand and dynamic content generated dynamically. In some embodiments, the static content may not change in its display contents according to conditions such as requests from the client terminal 200 and the passage of time. On the other hand, the dynamic content may change in its display contents according to conditions such as requests from the client terminal 200 and the passage of time.

The Web page generating unit 120 may generate a Web page in response to a request from the client terminal 200. If the generated Web page is to be made up solely of static content, the Web page may be generated from static content read out of the content storage unit 110. Also, if an entire Web page requested is stored as content in the content storage unit 110, the appropriate Web page may be read out of the content storage unit 110.

On the other hand, if a Web page generated in response to a request from the client terminal 200 contains dynamic content, the Web page generating unit 120 may generate the Web page by generating and incorporating necessary dynamic content. Here, some dynamic content, such as search results of a search engine, may be newly generated in response to a request from the client terminal 200. Also, as with advertisements displayed on a Web page, there may be instances in which content (such as an image) may itself be static, but different content is selected and displayed dynamically when a Web page is displayed or as time passes. In such instances, the static content to be selected may be selected from content stored, for example, in the content storage unit 110. Also, content, such as moving images, which in itself is dynamic may also be included in dynamic content.

In some embodiments, dynamic content can be incorporated in a Web page by various methods. For example, dynamic content can be described in the HTML file of the Web page using a script such as JavaScript®. Also, dynamic content can be set by reading other content into a region generated using a FRAME tag or IFRAME tag of the HTML. Various other techniques which can incorporate dynamic content into a Web page may also be used.

The request acceptance unit 130 may accept a request from the client terminal 200 via the network 300, and then send the accepted request to the Web page generating unit 120.

The transmission unit 140 may send back, via the network 300, the Web page generated by the Web page generating unit 120 to the client terminal 200 that sent the request accepted by the request acceptance unit 130.

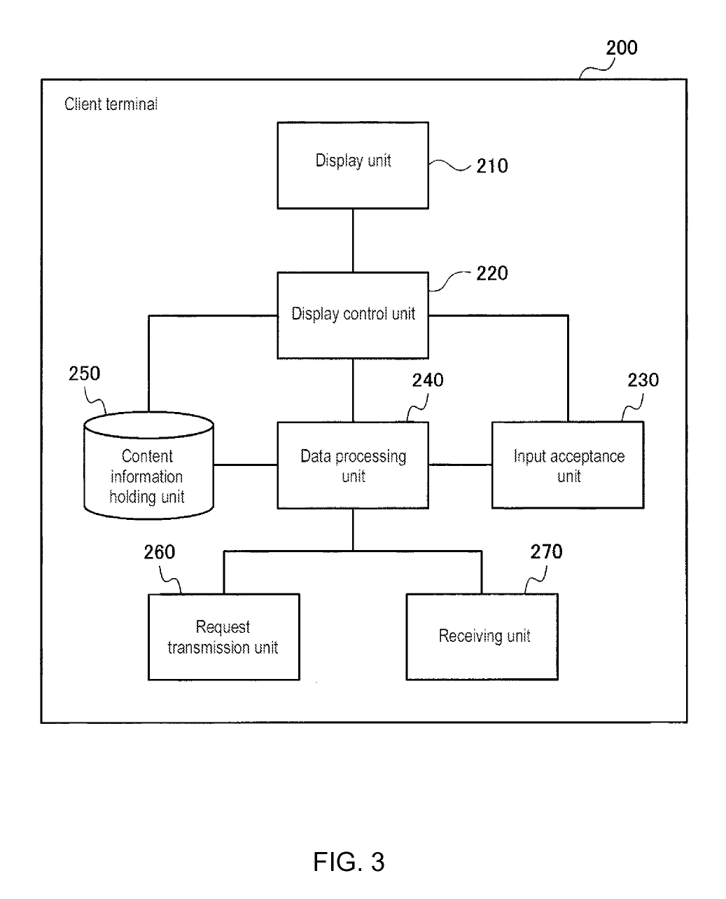

FIG. 3 is a diagram showing a functional configuration of the client terminal 200, in accordance with some embodiments of the present invention. The client terminal 200 according to some embodiments of the present embodiment may be an information processing apparatus such as a personal computer or personal digital assistant which can display a Web page acquired from the Web server 100. As shown in FIG. 3, the client terminal 200 includes a display unit 210, a display control unit 220, an input acceptance unit 230, a data processing unit 240, a content information holding unit 250, a request transmission unit 260, and a receiving unit 270.

The display unit 210, which is a display device such as a liquid crystal display, may display the Web page acquired from the Web server 100 on a display screen.

The display control unit 220, which may be implemented by a Web browser, may display the Web page acquired from the Web server 100 on the display unit 210. Also, as a function of the Web browser, the display control unit 220 may hold information such as history information and cookies of a displayed Web page. Also, the display control unit 220 according to some embodiments may determine whether or not dynamic content is contained in a Web page to be displayed. That is, the display control unit 220 may function as a dynamic content distinguishing unit.

In some embodiments, the determination as to whether or not dynamic content is contained in a Web page may be made by an appropriate technique according to the type of method used to incorporate the dynamic content into the Web page. Regarding the method used to incorporate the dynamic content into the Web page, various other techniques may be available. Thus, according to some embodiments, if a description which enables incorporating dynamic content exists in a source file (HTML file) of a Web page, it may be determined that dynamic content is contained in the Web page. Specifically, for example, if a script such as JavaScript® exists in the HTML file of a Web page, it may be determined that dynamic content is contained in the Web page. Also, if a FRAME tag or IFRAME tag is used in the HTML file of a Web page, it may be determined that dynamic content is contained in the Web page. Also, in some embodiments, a dictionary may be created in advance by registering characters expected to be used for URLs (Uniform Resource Locators) of static content. By conducting morphological analysis of the URL of Web content contained in a Web page, the URL may be checked for any character not registered in the dictionary. If the URL contains any character not registered in the dictionary, it may be determined that dynamic content is contained in the Web page. Note that the URL containing a character not registered in the dictionary may be assumed to be, for example, a URL generated automatically by a program.

In some embodiments, the input acceptance unit 230 may accept an input operation performed by a user based on a Web page displayed on the display unit 210. Specifically, the input acceptance unit 230 may accept text input, input of a command to transition to a link target, input of a command to call a function of a Web browser displaying a Web page, and the like. The command to call a function of a Web browser can be entered by selecting an appropriate one of various items, for example, from menus provided in a Web browser window displayed on the display unit 210. This may include a Web page transition based on a display history (“Back”), based on a display refresh as a result of reloading the Web page (“Reload”), or based on a registration in “Favorites” (Bookmark). The input acceptance unit 230 may be implemented by an existing input device, examples of which may include a pointing device such as a mouse, a keyboard, and a touch panel overlaid on a display screen of the display unit 210.

In some embodiments, based on the command and data accepted by the input acceptance unit 230, the data processing unit 240 may cause the display control unit 220 to control Web page display or to generate a request to be transmitted to the Web server 100. Also, when it is determined by the display control unit 220 that dynamic content is contained in the Web page to be displayed, the data processing unit 240 according to some embodiments may extract information on the target dynamic content from source code of the Web page. That is, the data processing unit 240 may function as a content information extraction unit adapted to extract information on dynamic content from the source code of the Web page. The process of extracting information on dynamic content performed by the data processing unit 240 is described herein.

In some embodiments, the content information holding unit 250 may hold information on the Web page being displayed on the display unit 210 by the display control unit 220 and information on the dynamic content extracted by the data processing unit 240. The information on the Web page held by the content information holding unit 250 may include, for example, the HTML file and URL of the Web page. Also, the information on the dynamic content held by the content information holding unit 250 may include, for example, data on the content itself (images and the like) and information identifying the content (link information and the like). Details of information about dynamic content are described herein.

In some embodiments, the request transmission unit 260 may transmit, via the network 300, the request generated by the data processing unit 240 to the Web server 100 specified as a destination of the request.

In some embodiments, the receiving unit 270 may receive the Web page transmitted from the Web server 100 via the network 300, and then send the received Web page to the display control unit 220.

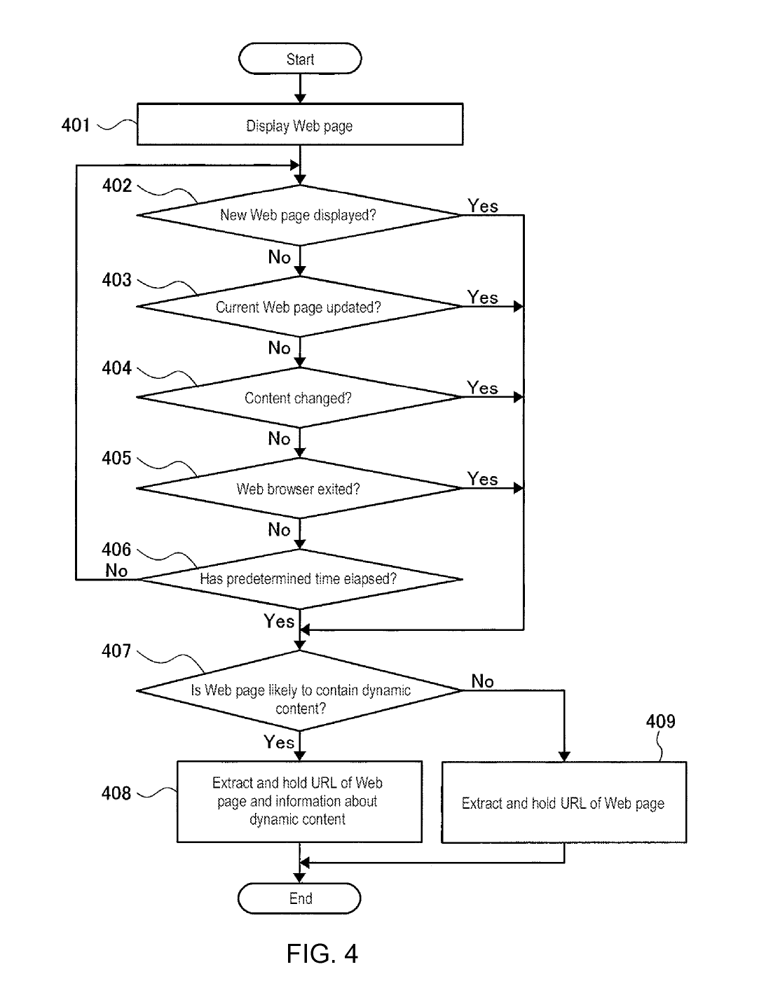

FIG. 4 is a flowchart describing a dynamic-content extraction process performed by the client terminal 200, in accordance with some embodiments of the present invention. The client terminal 200 may cause information about the Web page displayed on the display unit 210 to be held in the content information holding unit 250. Also, when dynamic content is contained in the Web page, the client terminal 200 may extract information about the dynamic content and cause the information to be held by the content information holding unit 250. Note that in the operation example described below, it is assumed that a URL rather than an HTML file itself is held as information about a Web page.

As shown in FIG. 4, the display control unit 220 of the client terminal 200 may display a Web page on the display unit 210 (step 401). It is assumed that as preliminary actions, a Web page transmission request may be made by the client terminal 200 to the Web server 100 via the request transmission unit 260 and the Web page related to the transmission request is returned from the Web server 100 to the client terminal 200. When the client terminal 200 receives the Web page via the receiving unit 270, the display control unit 220 may display the received Web page on the display unit 210.

Also, while the Web page is displayed on the display unit 210, the display control unit 220 may determine whether or not conditions (e.g., execution conditions) for acquiring information on dynamic content are satisfied (steps 402 to 406). In the example shown in FIG. 4, it may be determined as execution conditions whether or not a new Web page has been displayed (e.g., whether there has been a Web page transition) (step 402), whether or not the currently displayed Web page has been updated (e.g., reloaded) (step 403), whether or not the content contained in the currently displayed Web page has been changed (step 404), whether or not the Web browser has been exited (step 405), and whether or not a predetermined time has elapsed (step 406).

Note that in some embodiments information on dynamic content is acquired each time contents of dynamic content change. Thus, the concrete example shown in FIG. 4 is not restrictive, and in relation to various events in which contents of dynamic content are expected to change, occurrence of the events can be set as an execution condition. Also, it is not strictly necessary to use all the concrete execution conditions shown in FIG. 4 and only some of the conditions shown in steps 402 to 406 may be applied as execution conditions.

When any of the execution conditions above is satisfied (e.g., when determination in any of the steps is Yes), the display control unit 220 may determine whether or not the Web page being displayed may be likely to contain dynamic content (step 407). Here, the determination as to whether or not dynamic content is contained in a Web page may be made by checking for a description which enables incorporating dynamic content in the Web page, as described herein. Additional examples are also described herein. Note that the techniques described herein are only exemplary, and the method for determining whether or not dynamic content is contained is not limited to the described techniques.

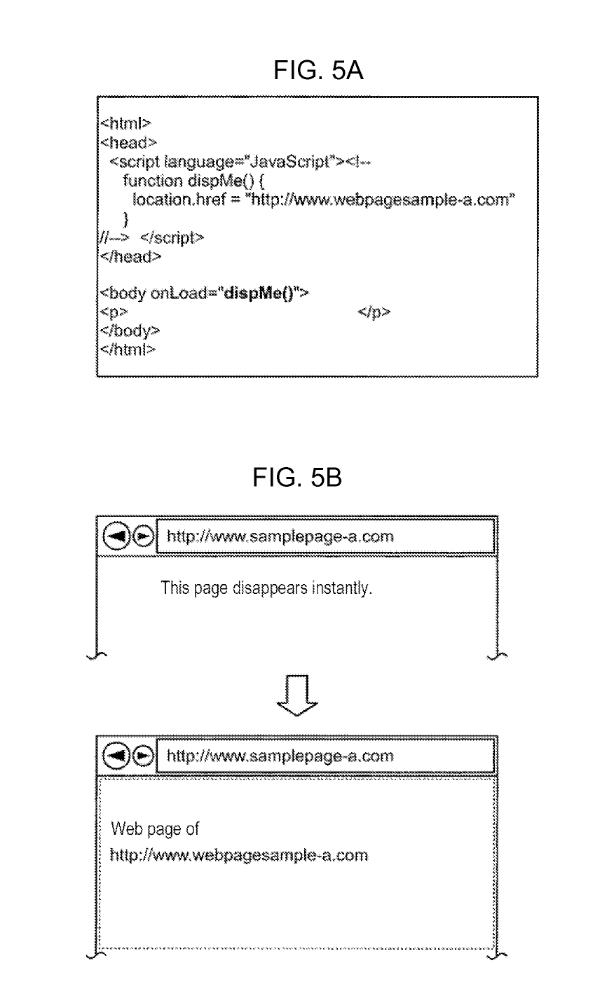

FIGS. 5(a) and 5(b) (collectively, “FIG. 5”) are diagrams showing an example of an HTML file of a Web page likely to contain dynamic content, where FIG. 5(a) is a diagram showing source code of the HTML file and FIG. 5(b) is a diagram showing a display example of the Web page, in accordance with some embodiments of the present invention. As with the example shown in FIG. 5, if a script (e.g., JavaScript®) exists in an HTML file (see, e.g., description of a tag <script language=“JavaScript”> to a tag </script>), display contents of the Web page may be likely to change when the script is executed.

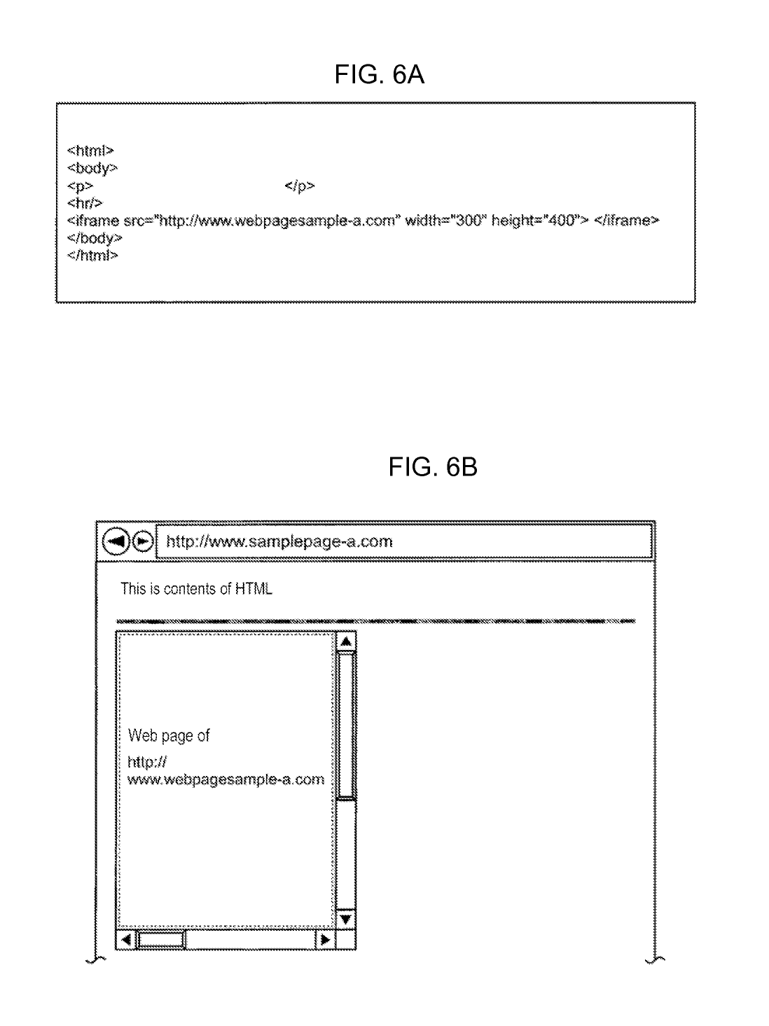

FIGS. 6(a) and 6(b) (collectively, “FIG. 6”) are diagrams showing another example of an HTML file of a Web page likely to contain dynamic content, where FIG. 6(a) is a diagram showing source code of the HTML file and FIG. 6(b) is a diagram showing a display example of the Web page, in accordance with some embodiments of the present invention. As with the example shown in FIG. 6, if an IFRAME tag is used in an HTML file (see, e.g., a tag <iframe src=“http://www.webpagesample-a.com” width=“300” height=“400”></iframe>), with content specified by a URL of “http://www.webpagesample-a.com” in the illustrated example, then the content described in the IFRAME tag may be displayed in a region on a Web page generated by the IFRAME tag. Consequently, each time the Web page is accessed, the content displayed in the region generated by the IFRAME tag may be likely to change.

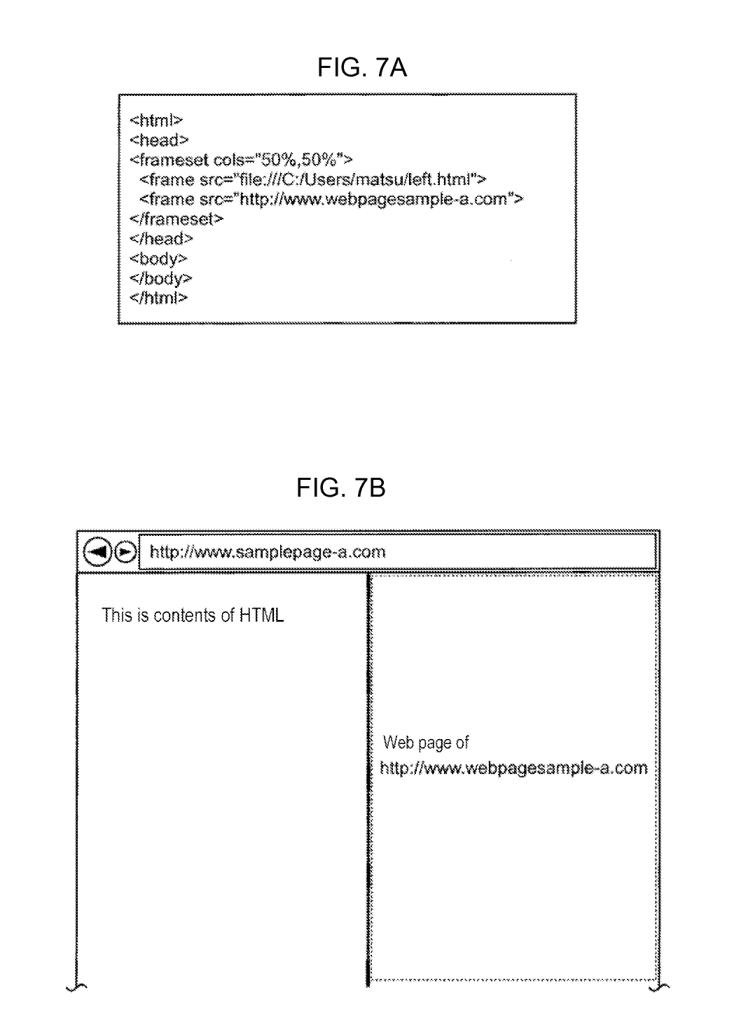

FIGS. 7(a) and 7(b) (collectively, “FIG. 7”) are diagrams showing another example of an HTML file of a Web page likely to contain dynamic content, where FIG. 7(a) is a diagram showing source code of the HTML file and FIG. 7(b) is a diagram showing a display example of the Web page, in accordance with some embodiments of the present invention. As with the example shown in FIG. 7, if a FRAME tag is used in an HTML file (see, e.g., the tag from <frameset cols=“50%,50%”> to </frameset>), then content specified by a URL (e.g., “http://www.webpagesample-a.com” in the illustrated example) described in the FRAME tag may be displayed in a region on a Web page generated by the FRAME tag. Consequently, each time the Web page is accessed, the content displayed in the region generated by the FRAME tag may be likely to change.

Also, in some embodiments, when morphological analysis of the URL (e.g., URL of content) described in the HTML file of a Web page is conducted, if the URL contains any character not registered in a dictionary created in advance by assuming character strings contained in typical URLs, the content specified by the URL may be likely to be dynamic content.

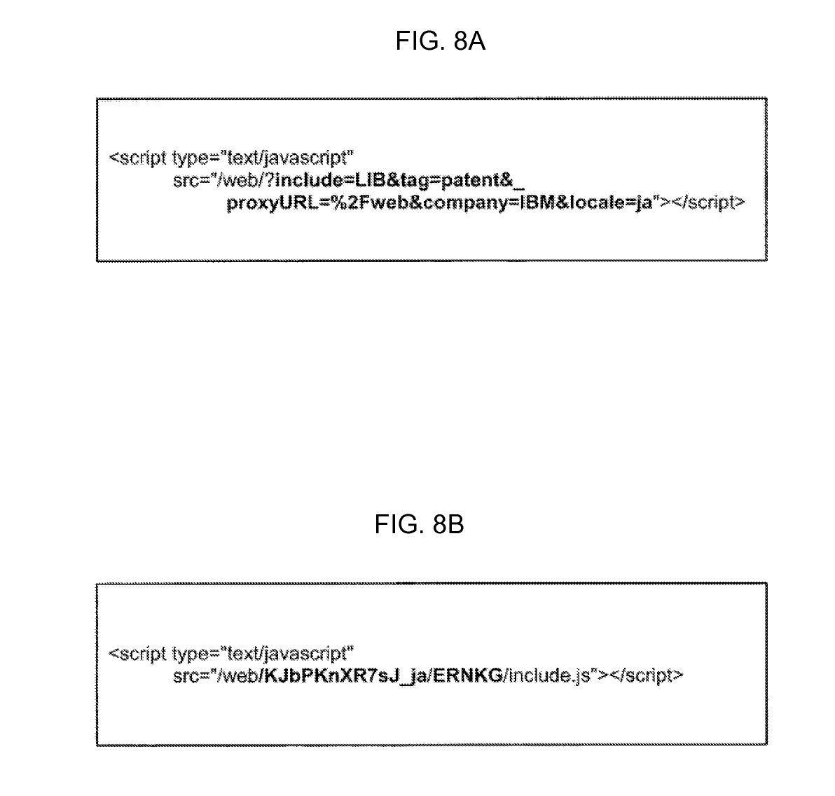

FIGS. 8(a) and 8(b) (collectively, “FIG. 8”) are diagrams showing special description examples in an HTML file of a Web page, in accordance with some embodiments of the present invention. Let us consider a case in which an HTML file contains a description such as the one shown in FIG. 8(a). In this example, a parameter is passed to a URL (see, e.g., the section “?include=LIB&tag=patent&_proxyURL=%2Fweb&company=IBM&locale=ja”). Normally, such a description is not used intentionally in URLs and is not registered in the dictionary described above. Thus, it is likely that the content specified by the URL is generated dynamically based on this parameter.

Let us consider a case in which an HTML file contains a description such as the one shown in FIG. 8(b). In this example, the URL contains a description of a path likely to have been generated dynamically based on a random number (see, e.g., the section “/web/KJbPKnXR7sJ_ja/ERNKG/includejs”). That is, it is likely that a temporary file name is exchanged between browser and server using a key created randomly or mechanically. Normally, such a description is not used intentionally in URLs and is not registered in the dictionary described above. Thus, it is likely that the content specified by the URL is generated dynamically based on information exchange between the browser (client terminal 200) and Web server 100.

Returning now to FIG. 4, if it is determined by the display control unit 220 that the Web page is likely to contain dynamic content as described above, then, using the function of the Web browser, the data processing unit 240 may extract the URL of the Web page and information about dynamic content from the HTML file of the Web page and cause the content information holding unit 250 to hold the extracted URL and information (step 408). As to the information about dynamic content, information may be selected which will allow a display of the currently displayed dynamic content to be reproduced when the currently displayed Web page is displayed again. In other words, the information about the dynamic content may be identification information which identifies contents of the displayed dynamic content. For example, when dynamic content is generated dynamically on the Web server 100, the image itself currently displayed on the display unit 210 may be held as the information about the dynamic content. In contrast, if dynamic content is such that predetermined static content has been selected on the Web server 100 and incorporated into the Web page as the dynamic content, the image currently displayed on the display unit 210 is set to be the information about the dynamic content and link information (e.g., the URL and the like) about the image currently displayed may be held as information about the dynamic content.

Note that, in some embodiments, since multiple execution conditions for acquiring information about dynamic content are set as shown in steps 402 to 406, multiple pieces of information may be held for one piece of dynamic content on a currently displayed Web page depending on the execution conditions. Also, in some embodiments, when there are multiple pieces of dynamic content on one Web page, information may be held for each piece of dynamic content according to the execution conditions.

On the other hand, if it is determined by the display control unit 220 that the Web page is not likely to contain dynamic content (e.g., that the entire Web page is static content), the data processing unit 240 may extract only the URL of the Web page from the HTML file of the Web page and cause the content information holding unit 250 to hold the URL (step 409).

In some situations, when a “Back” command of a Web browser is entered, a Web page displayed before the currently displayed Web page is redisplayed by a function of the Web browser based on saved history information. According to the some embodiments, the Web page may be redisplayed based on the information held by the content information holding unit 250 in steps 408 and 409 of FIG. 4 and used as history information. Note that in the operation example described below, it is assumed that one piece of dynamic content may be contained in a Web page.

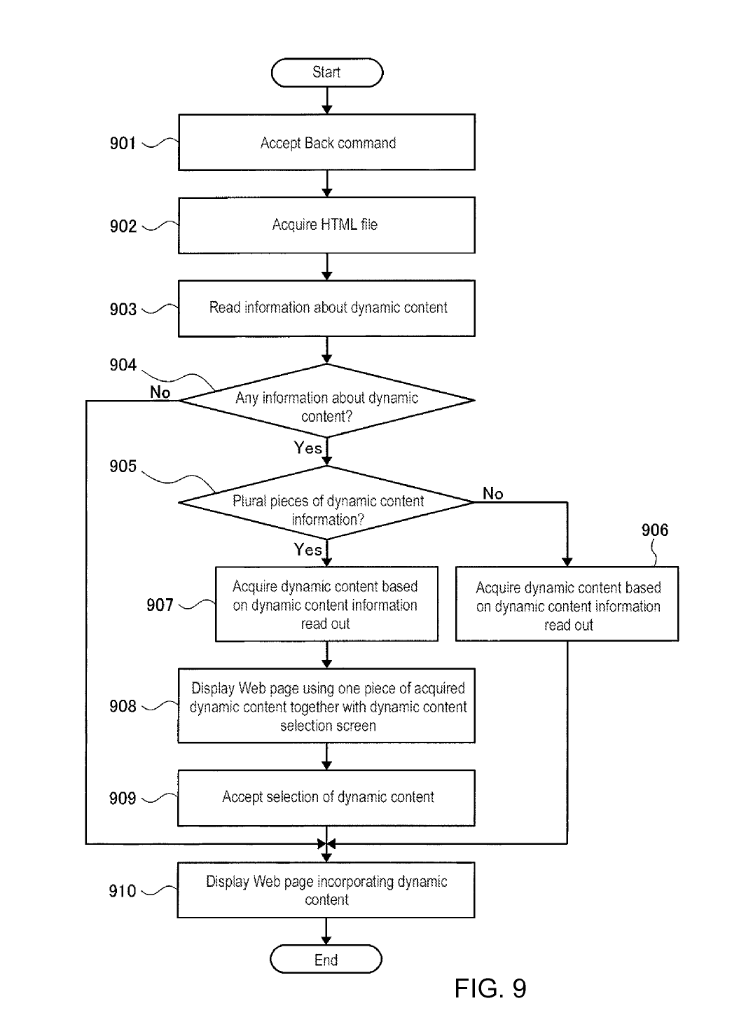

FIG. 9 is a flowchart describing a Web page redisplay process based on history information, in accordance with some embodiments of the present invention. As shown in FIG. 9, when a “Back” command of a Web browser is accepted by the input acceptance unit 230 (step 901), the Web browser display control unit 220 may read, out of the content information holding unit 250, the URL of the Web page at a transition destination specified by the “Back” command and may acquire the HTML file of the Web page based on the URL read out (step 902). Also, the display control unit 220 may read, out of the content information holding unit 250, the dynamic content information held in the content information holding unit 250, with the dynamic content being contained in the Web page at the transition destination specified by the “Back” command (step 903).

If there is no dynamic content information to be read out (No in step 904), dynamic content may not exist in the Web page at the transition destination. Thus, the display control unit 220 may display the Web page corresponding to the HTML file acquired in step 902 on the display unit 210 (step 910).

Also, if there is one piece of dynamic content information to be read out (Yes in step 904 and No in step 905), the display control unit 220 may acquire dynamic content (step 906) based on the dynamic content information read out of the content information holding unit 250 in step 903. Then, the display control unit 220 may incorporate the dynamic content acquired in step 906 into the Web page corresponding to the HTML file acquired in step 902 and display the Web page on the display unit 210 (step 910). Here, if the information about dynamic content is data on content itself such as an image, the content read out of the content information holding unit 250 may be incorporated as it is into the Web page. On the other hand, if the information about dynamic content is link information about content, the content may be acquired based on the link information and the acquired content may then be incorporated into the Web page. Also, the content to be incorporated into the Web page may be acquired according to the form of dynamic content information read out.

On the other hand, if there are plural pieces of dynamic content information to be read out (Yes in step 904 and Yes in step 905), the display control unit 220 may acquire the plural pieces of dynamic content (step 907) based on the plural pieces of dynamic content information read out of the content information holding unit 250 in step 903. Then, one piece of the acquired dynamic content may be incorporated into the Web page corresponding to the HTML file acquired in step 902 and then displayed on the display unit 210 (step 908). In so doing, the dynamic content incorporated into the Web page may be any of the acquired pieces of dynamic content, and, for example, may be the piece of dynamic content displayed last.

Also, on the display unit 210, the display control unit 220 may display a selection screen used to select contents of dynamic content to be displayed on the Web page (step 908). Based on the selection screen presented on the display unit 210, the user can select a Web page containing dynamic content in a desired state via the input acceptance unit 230. When the user selects a Web page (e.g., Page N) containing the desired dynamic content, the data processing unit 240 may accept the selection (step 909). Then, the display control unit 220 may display the Web page incorporating the selected dynamic content on the display unit 210 (step 910).

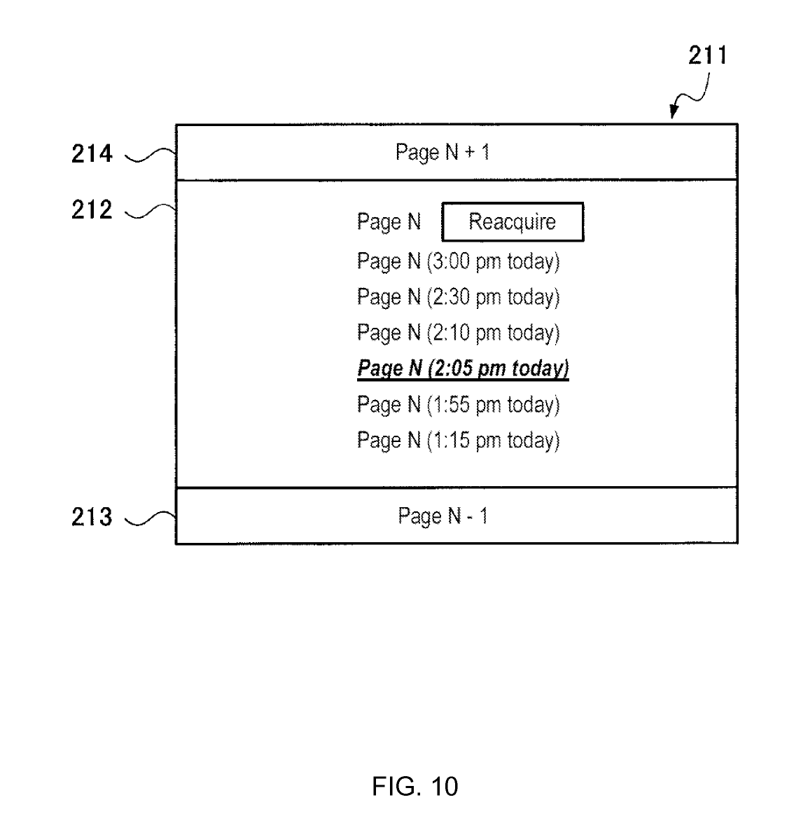

FIG. 10 is a diagram showing an example of a selection screen, in accordance with some embodiments of the present invention. A selection screen 211 shown in FIG. 10 may present a list 212 of dynamic content information about a Web page “Page N” by acquiring the dynamic content information each time the contents of dynamic content change. Each list item may describe the time at which dynamic content information was held. Also, in the illustrated example, the bottom row is “Page N” which contains the dynamic content displayed first, and from there the higher in the list, the newer the dynamic content contained in “Page N.” A Reacquire button may be displayed in the top row to newly reacquire the HTML file of “Page N” containing dynamic content from the Web server 100. When the user clicks the Reacquire button, the HTML of “Page N” is reloaded. Also, “Page N” displayed in step 908 (e.g., “Page N” currently displayed as a result of execution of the Back command) may be highlighted (e.g., displayed in boldface, with underline, or in italic) in the list 212 on the selection screen 211. The illustrated example shows “Page N” containing the dynamic content based on the dynamic content information held at 2:05 pm today. Also, in the selection screen 211 shown in FIG. 10, a button 213 is provided in a bottom part to display a list of dynamic content information about a Web page “Page N−1” immediately previous to “Page N” and a button 214 is provided in a top part to display a list of dynamic content information about a Web page “Page N+1” immediately next after “Page N”.

Note that although in the example shown in FIG. 10, the list 212 is displayed only for “Page N” with only list buttons 213 and 214 being provided for “Page N−1” and “Page N+1”, in some embodiments a list may be displayed for each of “Page N−1”, “Page N”, and “Page N+1”. Also, although in the operation example described above the Web page contains one piece of dynamic content, if the Web page contains multiple pieces of dynamic content, the above process may be performed for each piece of the dynamic content and the selection screen may be configured to allow a selection to be made for each piece of the dynamic content. In that case, a selection screen for use in selecting dynamic content to be incorporated into the Web page may be provided individually for each of multiple pieces of dynamic content or a single selection screen may be configured to be used in selecting multiple pieces of dynamic content.

The selection screen 211, according to some embodiments, may hold multiple pieces of dynamic content information for one piece of dynamic content, and when multiple Web pages containing dynamic content can be constructed according to the contents of dynamic content, it may be sufficient if a Web page containing desired dynamic content can be selected. As such, the present invention may not be limited to the configuration shown in FIG. 10. For example, in some embodiments, dynamic content based on held dynamic content information or images of Web pages containing the dynamic content may be converted into thumbnail images or the like and displayed side by side, thereby allowing the user to make a selection by referring to display conditions of the Web pages. Also, for example, on the Web page displayed in step 908 of FIG. 9, a display location of dynamic content may be displayed in a distinguishable manner and different pieces of dynamic content acquired based on information held in the content information holding unit 250 may be displayed switchably in the display location, allowing the user to make a selection.

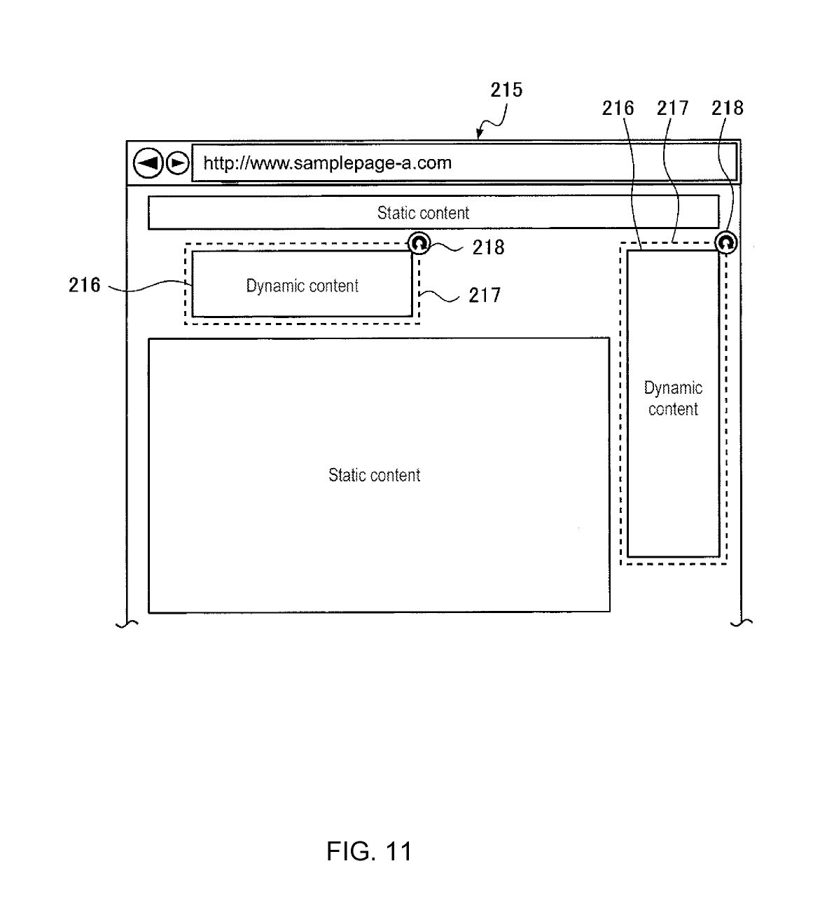

FIG. 11 is a diagram showing an example configuration of a selection screen which switchably displays dynamic content on a Web page, in accordance with some embodiments of the present invention. A selection screen 215 shown in FIG. 11 may be comprised of the Web page created in step 908 of FIG. 9. The selection screen 215 contains two pieces of dynamic content 216. Each piece of the dynamic content 216 is highlighted 217 (using, for example, blinking frame lines or the like as indicated by dashed lines in the illustrated example), allowing the user to distinguish the dynamic content. Also, a button object 218 may be displayed at the upper right corner of the dynamic content 216. When the user clicks the button object 218, the clicked dynamic content 216 is replaced with other dynamic content for the display location acquired based on information held in the content information holding unit 250. In this way, the user can switchably display dynamic content on a Web page and select desired dynamic content.

Incidentally, in the operation example described above, when there is one piece of dynamic content information to be read out, dynamic content may be acquired, in some embodiments, simply based on the dynamic content information read out of the content information holding unit 250 (see steps 905 and 906 of FIG. 9). In contrast, even if there is one piece of dynamic content information, a selection screen such as the one shown in FIG. 10 may be displayed, allowing the user to select whether to display the HTML file of the Web page reacquired from the Web server 100 or display the Web page incorporating dynamic content which is based on information read out of the content information holding unit 250.

Also, although the operation of redisplaying a previously displayed Web page in response to a “Back” command of the Web browser has been described in the above operation example, a similar process may be applied to dynamic content also when a currently displayed Web page is reloaded and redisplayed in response to a “Reload” command of the Web browser. That is, in some embodiments, dynamic content displayed previously can be displayed in redisplaying a Web page when contents of the dynamic content on the currently displayed Web page have been changed.

For example, the following process is usable in some embodiments. First, when a “Reload” command of the Web browser is entered, the HTML file of the currently displayed Web page is reacquired from the Web server 100 by a function of the Web browser. Then, regarding the dynamic content contained in the currently displayed Web page, the display control unit 220 reads information about the dynamic content out of the content information holding unit 250 in a manner similar to step 903 of FIG. 9. If there is no dynamic content information to be read out, the display control unit 220 may display the Web page reacquired in response to the “Reload” command on the display unit 210.

On the other hand, if there is dynamic content information to be read out, the display control unit 220 may display the Web page reacquired in response to the “Reload” command on the display unit 210 and display a selection screen used to select contents of dynamic content to be displayed on the Web page on the display unit 210 in a manner similar to step 908 of FIG. 9. Then, based on the user's selection, the display control unit 220 may display the Web page incorporating the selected dynamic content on the display unit 210. In this way, when a Web page is reloaded and redisplayed, by making previously displayed dynamic content selectable, it may be possible to display desired dynamic content displayed previously on a Web page containing dynamic content whose display is changed at fixed intervals.

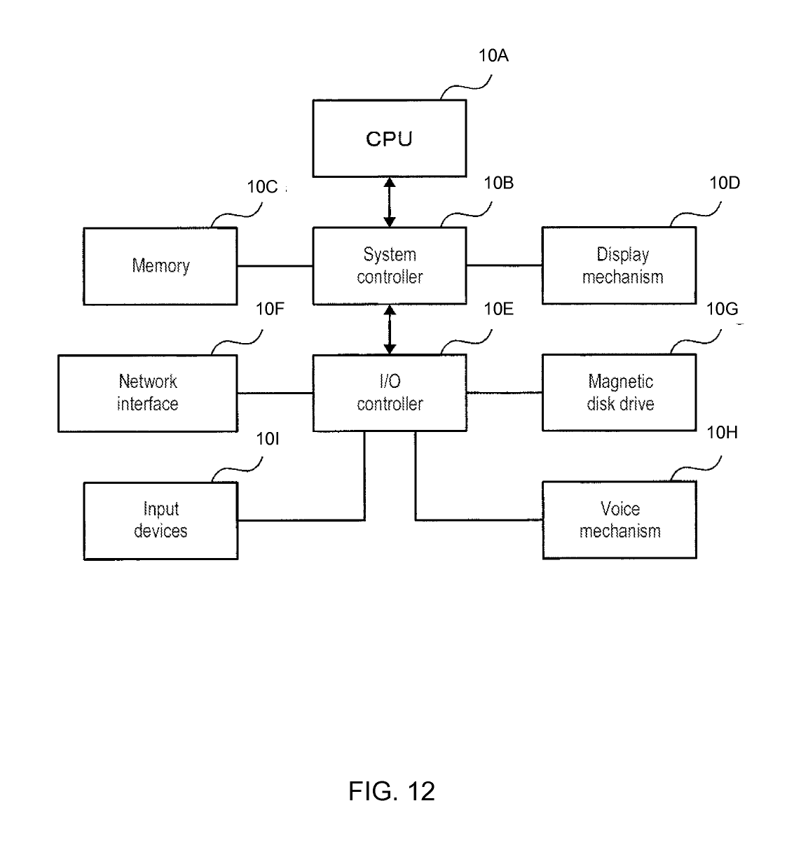

FIG. 12 is a diagram showing an example hardware configuration suitable for constructing the client terminal 200, in accordance with some embodiments of the present invention. Application to a computer is described herein. A computer shown in FIG. 12 includes a CPU (Central Processing Unit) 10A which may be computing means and a memory 10C which may be main storage means. Also, as external devices, the computer is provided with a magnetic disk drive (HDD: Hard Disk Drive) 10G, a network interface 10F, a display mechanism 10D including a display device, a voice mechanism 10H, and input devices 10I such as a key-board and mouse, and the like.

In the configuration example shown in FIG. 12, the memory 10C and display mechanism 10D are connected to the CPU 10A via a system controller 10B. Also, the network interface 10F, magnetic disk drive 10G, voice mechanism 10H, and input devices 10I are connected to the system controller 10B via an I/O controller 10E. The components are interconnected via various buses such as a system bus and input/output bus.

Note that FIG. 12 merely illustrates by example a hardware configuration of a computer to which some embodiments may be applied suitably. Some embodiments may not only be implemented in the illustrated configuration, but also may be widely applicable to information processors having a function of a Web browser which displays a Web page acquired from a Web server 100, making the Web page available for viewing.

In FIG. 12, OS programs and applications programs are stored in the magnetic disk drive 10G. When these programs are loaded into the memory 10C and executed by the CPU 10A, the functions of the display control unit 220 and data processing unit 240 on the client terminal 200 according to some embodiments may be implemented. Also, the content information holding unit 250 may be implemented by storage means such as the memory 10C and magnetic disk drive 10G. Also, the display unit 210 may be implemented by the display mechanism 10d while the input acceptance unit 230 may be implemented by the input devices 10I. Also, the request transmission unit 260 and receiving unit 270 may be implemented by the network interface 10F.

In some embodiments, a program may cause a computer for displaying Web pages on a display to function as (i) means for distinguishing whether or not a Web page displayed on the display device contains dynamic content; (ii) means for extracting identification information which identifies contents of displayed dynamic content from the Web page, in response to the Web page being determined by the dynamic content distinguishing means to contain the dynamic content and make a storage device hold the identification information; and (iii) means for controlling display of Web pages on the display device, and, if dynamic content is contained in a Web page to be newly displayed and the identification information about the dynamic content is held in the storage device, display the dynamic content of the newly displayed Web page based on the identification information held in the storage device.

What is claimed is:

1. An apparatus for displaying Web pages on a display device, comprising:
a dynamic content distinguishing unit adapted to distinguish whether or not a Web page displayed on the display device contains dynamic content;
a content information extraction unit adapted to extract identification information which identifies contents of displayed dynamic content from the Web page displayed on the display device, in response to the Web page being determined by the dynamic content distinguishing unit to contain the dynamic content;
a content information holding unit adapted to hold the identification information extracted by the content information extraction unit; and
a display control unit adapted to control display of Web pages on the display device, and, if dynamic content is contained in a Web page to be newly displayed and the identification information about the dynamic content is held in the content information holding unit, display the dynamic content of the newly displayed Web page based on the identification information held in the content information holding unit.

2. The apparatus according to claim 1, wherein if there are a plurality of pieces of the identification information about the dynamic content contained in the newly displayed Web page, the display control unit is further adapted to accept selection of contents of the dynamic content by a user, and displays the dynamic content based on the identification information about the selected contents of the dynamic content.

3. The apparatus according to claim 1, wherein when a Web page displayed on the display device prior to a currently displayed Web page is to be redisplayed as the Web page to be newly displayed, the display control unit is further adapted to display dynamic content contained in the Web page to be newly displayed, based on the identification information held in the content information holding unit.

4. The apparatus according to claim 1, wherein if a currently displayed Web page is to be reloaded and redisplayed as the Web page to be newly displayed, the display control unit is further adapted to display dynamic content contained in the Web page to be newly displayed, based on the identification information held in the content information holding unit.

5. The apparatus according to claim 1, wherein when a Web page containing dynamic content is displayed on the display device, the content information extraction unit is further adapted to extract the identification information about the dynamic content.

6. The apparatus according to claim 1, wherein when dynamic content contained in the Web page displayed on the display device is reloaded, the content information extraction unit is further adapted to extract the identification information about the dynamic content.

7. The apparatus according to claim 1, wherein when displaying a Web page containing dynamic content is finished, the content information extraction unit is further adapted to extract the identification information about the dynamic content.

8. The apparatus according to claim 1, wherein the content information extraction unit is further adapted to extract the identification information about the dynamic content at each predetermined time.

9. The apparatus according to claim 1, wherein the content information extraction unit is adapted to extract the identification information at least when the Web page is displayed on the display device and when the dynamic content contained in the Web page is updated, and wherein the display control unit is adapted display the dynamic content of the newly displayed Web page based on the identification information held in the content information holding unit when a Web page displayed on the display device prior to a currently displayed Web page is to be redisplayed.

10. A method for displaying Web pages on a display device, comprising the steps of:
checking, in relation to dynamic content contained in a Web page to be newly displayed on the display device, whether or not identification information which identifies contents of the dynamic content at a specific time point is held, if the Web page is the same Web page as a currently displayed Web page or is a Web page displayed previously; and
displaying the dynamic content of the newly displayed Web page based on the identification information about the dynamic content contained in the newly displayed Web page if the identification information is held.

11. The method according to claim 10, further comprising a step of extracting the identification information which identifies contents of the displayed dynamic content from the Web page displayed on the display device and holding the identification information.

12. A method comprising:
obtaining a uniform resource locator (URL) for a first Web page;
providing, by using the URL to retrieve the first Web page, a first version of the first Web page, the first version of the first Web page including visual static content and a first content version of a plurality of content versions of visual dynamic content, the visual static content configured to remain the same each time the first Web page is displayed and the visual dynamic content configured to change between the plurality of content versions each time the first Web page is displayed;
determining that there is visual dynamic content contained in the first Web page;
extracting, in response to the determining, identification information for the first content version of the visual dynamic content;
switching from, after the extracting the identification information, the providing the first version of the first webpage to providing a second webpage; and
reproviding, after the switching, the first version of the first Web page by using the URL to retrieve the static content of the first Web page and by using the identification information to retrieve the first content version of the dynamic content.

13. The method of claim 12, wherein the identification information for the first content version of the visual dynamic content is extracted from a hypertext markup language (HTML) file for the first Web page.

14. The method of claim 13, wherein the identification information is non-URL information.

15. The method of claim 12, wherein the determining that there is visual dynamic content contained in the first Web page comprises:
comparing the characters of the URL to a dictionary containing character strings commonly contained in URLs;
identifying, based on the comparing, at least one character string in the URL that is not one of the character strings commonly contained in URLs.

16. The method of claim 12, wherein the determining that there is visual dynamic content contained in the first Web page comprises identifying content described in an IFRAME tag, and wherein the content described in the IFRAME tag becomes the extracted identification information for the first content version of the visual dynamic content.

17. The method of claim 12, wherein, as reprovided, the first version of the first Web page includes a highlight on the visual dynamic content, the method further comprising:
receiving, while reproviding the first version of the first Web page, a user request that specifies a second version of the first Web page, the second version of the first Web page including the visual static content and a second content version of the plurality of content versions of the visual dynamic content; and
switching, in response to the receiving the user request, from the reproviding the first version of the first Web page to providing the second version of the first Web page by:
continuing to provide the visual static content and the highlight on the visual dynamic content; and
changing from providing the first content version to providing the second content version of the visual dynamic content.
